(19) United States
(12) Patent Application Publication
(10) Pub. No.: US 2009/0057344 A1
(43) Pub. Date: Mar. 5, 2009

(54) All spicer

(76) Inventor: Harvey A. Henry, Monmouth, OR (US)

Correspondence Address: Christine Sisco-Henry, 479 South Broad St., Monmouth, OR, 97361, US

(21) Appl. No.: 11/820,501

(22) Filed: Aug. 31, 2007

(51) Int. Cl. B67D 5/06; B65D 88/54

(52) U.S. Cl. 222/144.5; 222/333

(57) ABSTRACT

The allspicer is an automatic spice dispenser that holds, stores and dispenses spice's. It has a Menu memory, a alphabetical listing of spice's, measurement screen as to how much of Each spice you wish to drop out. The spice's would drop out just like a coffee machine that You put money in and a predetermined amount pours into your cup. The spice would drop out The amount you choose and drop it out into a dispense cup.

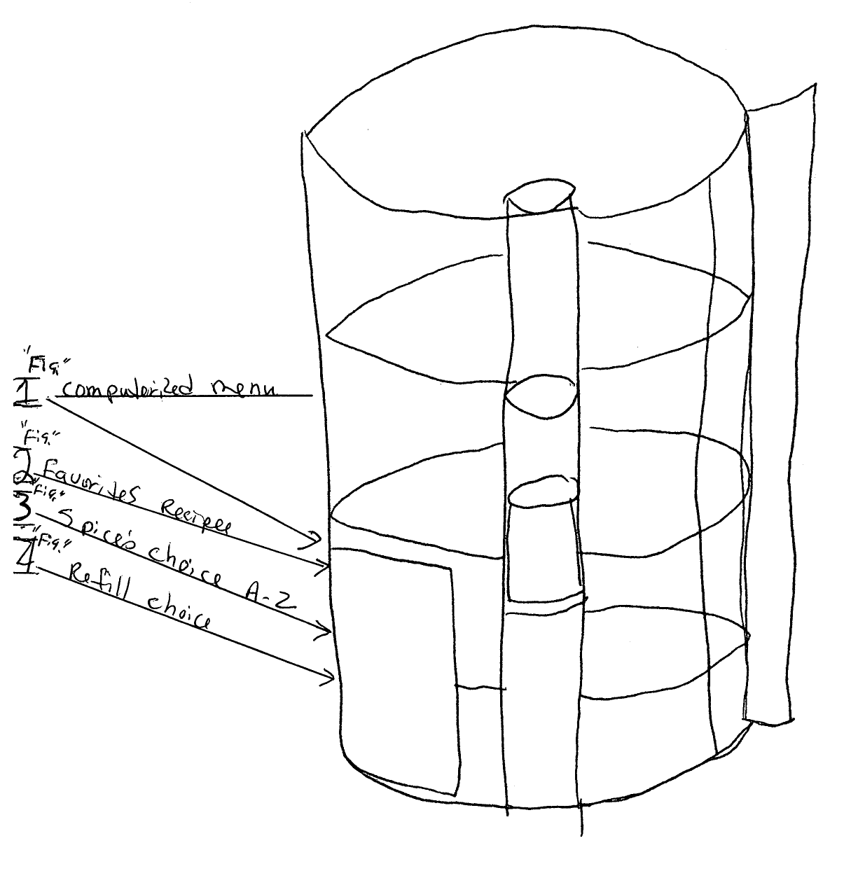

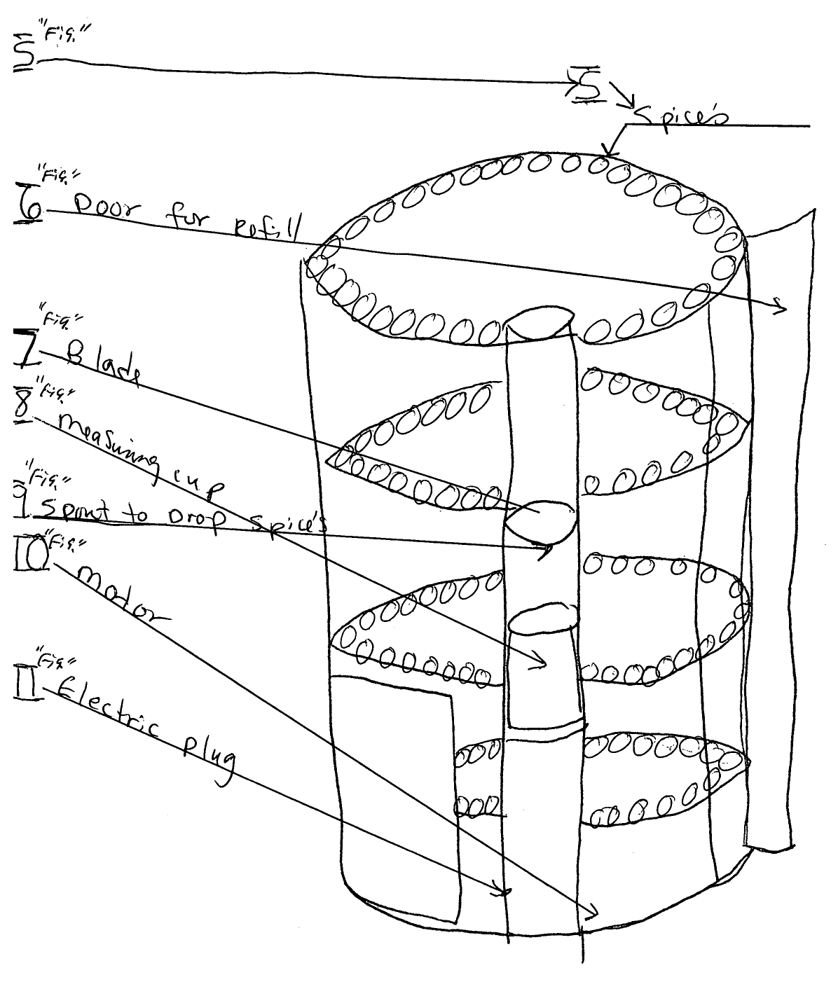

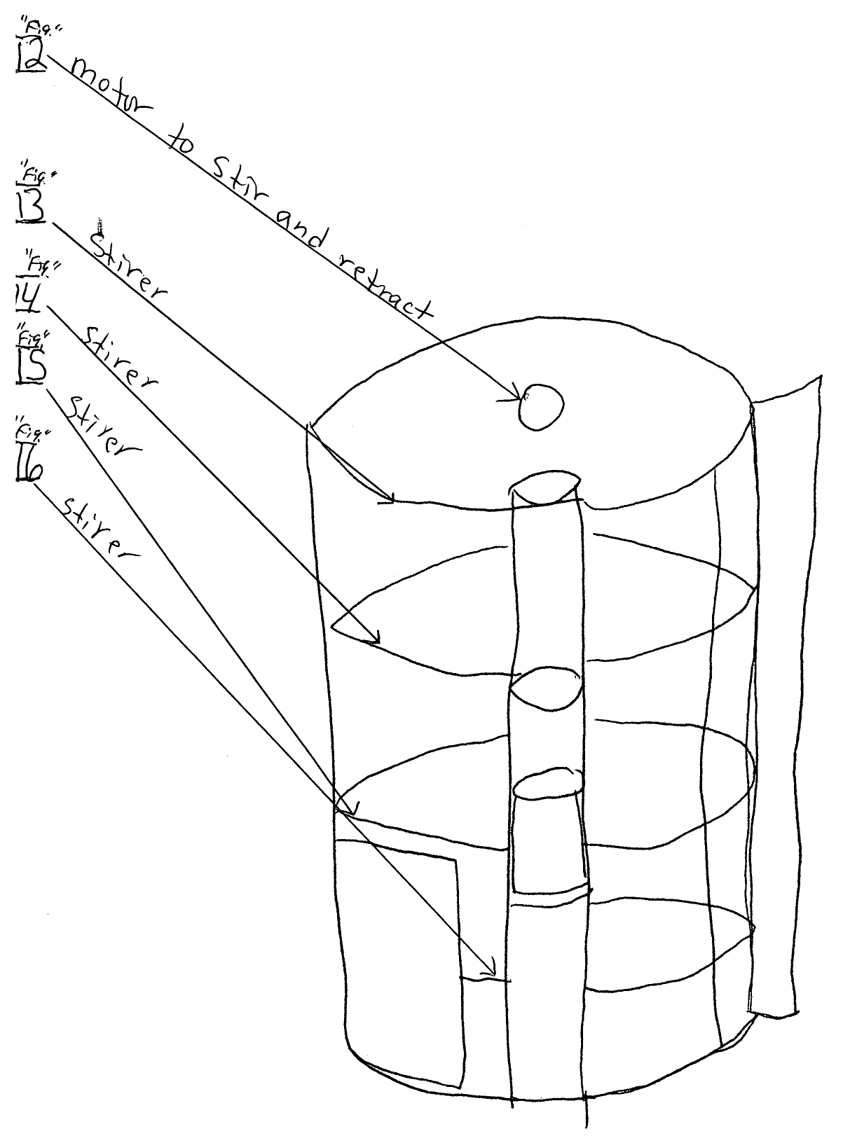

### BACKGROUND OR PROBLEM

In households with a sufficiently stocked pantry, the numerous jars or containers of spices Take up significant counter or cupboard space due to their varying size or height. Searching for an infrequently used spice is a time consuming process, as, odds are, it was Pushed to the back of the cabinet. In addition, spices that are not commonly used may Harden in their containers.

### SOLUTION

Allspicer is an automatic spice dispenser that utilizes computerized technology to Efficiently measure and dispense spices. This system eliminates a cluttered cupboard by Storing all spices in a centralized unit and cuts down on the user's cooking or baking time By quickly locating and measuring out the desired spices.

### DETAILED DESCRIPTION OF INVENTION

Allspicer is an automatic spice dispenser that conveniently combines all spices into a single Unit that utilizes a computerized touch screen system to correctly measure and dispense the desired spice. Allspicer measures approximately 15″ high, has a 36″ circumference and also features a traditional electrical plug system as well as a centralized motor. Spices are situated in a circle on a lazy-susan type piece so that they spin around until the desired spice is situated at the at the measuring/dispensing area. The unit can feature 3 or 4 levels of spices. Once the spice is situated at the measuring chamber, a safely contained blade and a dispensing cup move up to that level and the blade move across the spice in a horizontal motion to measure out the desired amount of the spice based on weight. The blade then holds in the excess spice that is located above it. While the bottom of the dispensing chamber opens up utilizing a simultaneously swinging door method to drop out the spice. Utilizing preexisting computerized touch screen technology, the allspicer features a computerized menu that is located near the bottom of the unit. This menu is comprised of three categories: favorites, spices and refills. In the favorites section, the computer will be capable of remembering pre-entered spice combinations of favorite or frequently used recipes and capable of remembering pre-entered spice combinations of favorite or frequently used recipes and will automatically put all of these spices in the dispensing cup at one time. The spices section would feature an alphabetized listing of all available spices, and with a tough of the screen, the allspicer will obtain the needed seasoning and drop it out automatically by a timer located in the system. To ensure adequate amounts of spices, the refill section would compile a list of spices whose levels were low or empty based on weight in the computerized system in the unit. After choosing a spice, the unit would rotate that spice to a refill chamber located on the outside of the unit and spout will pop out the side/with a door to be opened automatically by computer. The spices for this system would have a food softener or preservative to ensure that they would be kept soft for dispensing or the unit could automatically stir the spices after a predetermined amount of time using a stirrer mechanism that would be situated in the unit. This unit could be manufactured in a variety of colors.

### DESCRIPTION OF FIGURES ARE

1. Computerized menu is the display screen.
2. Favorites recipe button
3. Spice choice button listed from A-Z
4. Refill choice button. Chooses a spice to be refilled
5. Spice holding containers
6. Door for refilling spices spice pops out for filling.
7. Blade to cut out right measurement of spice
8. Measuring cup to hold spice in
9. Spout to drop out spice
10. Motor that is electric and computerized
11. Electric plug to plug into outlet
12. Motor to stir spice's and retracts up and down
13. Stirrer to stir spice on level one
14. Stirrer to stir spice on level two
15. Stirrer to stir spice on level three
16. Stirrer to stir spice on level four

We (Harvey and Christine Henry) claim that this machine is:

1. electric

2. It holds spice's

3. It dispenses spice's
